(19) United States
(12) Patent Application Publication
(10) Pub. No.: US 2026/0128895 A1
(43) Pub. Date: May 7, 2026

(54) ENHANCED DISTRIBUTED ZERO-KNOWLEDGE PROOF GENERATION

(71) Applicant: The Hong Kong University of Science and Technology, Kowloon (HK)

(72) Inventors: Pingchuan MA, Kowloon (HK); Shuai WANG, Kowloon (HK); Zhaoyu WANG, Kowloon (HK)

(21) Appl. No.: 19/173,756

(22) Filed: Apr. 8, 2025

Related U.S. Application Data
(60) Provisional application No. 63/714,884, filed on Nov. 1, 2024.

(51) Int. Cl. H04L 9/32

(52) U.S. Cl. CPC H04L 9/3221; H04L 9/3236

(57) ABSTRACT

Zero-knowledge proof (ZKP) generation can be enhancedly managed and performed. Proof manager can decompose directed acyclic graph (DAG) representative of data analytics workflow into respective sub-DAGs representative of respective workflow portions. Based on respective sub-DAGs, proof manager can determine respective sub-ZKPs relating to respective workflow portions and sub-DAGs. Respective sub-ZKPs can be concurrently determined using respective servers. Proof manager can hash respective input and output values of respective sub-DAGs and include respective hashed values in respective sub-ZKPs. Based on linking respective sub-ZKPs having respective hashed values that satisfy a defined match criterion, proof manager can determine and generate ZKP relating to the workflow, comprising computation results. Proof manager can communicate ZKP to a verifier to facilitate verification of correctness of ZKP, including the computation results. Proof manager can store sub-ZKPs and reuse a stored sub-ZKP that relates to a computation of a sub-DAG of another workflow.

### CROSS-REFERENCE TO RELATED APPLICATION

This patent application claims priority to U.S. Provisional Patent Application No. 63/714,884, filed Nov. 1, 2024, and entitled, “A New Approach for Distributed Zero-Knowledge Proof Generation for Data Analytics Workflow,” the entirety of which application is hereby incorporated by reference herein.

### BACKGROUND

Various cryptographic tools can be utilized to protect data. For instance, zero-knowledge proofs can be a cryptographic tool that can enable a prover to convince a verifier of the correctness of computations without revealing the underlying data utilized in performing the computations and generating the zero-knowledge proof.

The above-described description is merely intended to provide a contextual overview regarding cryptographic tools and proofs, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise decomposing, by a system comprising at least one processor, a graph representative of a workflow into respective subgraphs representative of respective portions of the workflow. The method also can comprise: based on the respective subgraphs, determining, by the system, respective subproofs relating to the respective portions of the workflow and the respective subgraphs. The method further can comprise: based on the respective subproofs, generating, by the system, a proof relating to the workflow.

In certain embodiments, the disclosed subject matter can comprise a system that can comprise at least one memory that can store computer executable components, and at least one processor that can execute computer executable components stored in the at least one memory. The computer executable components can comprise a decomposer that can decompose a graph representative of a workflow into respective subgraphs relating to respective portions of the workflow. The computer executable components also can comprise a proof generator that, based on the respective subgraphs, can determine respective subproofs relating to the respective portions of the workflow and the respective subgraphs, to facilitate generation of a proof relating to the workflow.

In still other embodiments, the disclosed subject matter can comprise a non-transitory machine-readable medium, comprising executable instructions that, when executed by at least one processor, can facilitate performance of operations. The operations can comprise segmenting a directed acyclic graph representative of a workflow into respective directed acyclic subgraphs relating to respective portions of the workflow. The operations also can comprise: based on the respective directed acyclic subgraphs, generating respective subproofs relating to the respective portions of the workflow and the respective directed acyclic subgraphs. The operations further can comprise: based on the respective subproofs, generating a proof relating to the workflow.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably perform and manage proof generation for datasets, in accordance with various aspects and embodiments of the disclosed subject matter.

FIG. 2 depicts a block diagram of a non-limiting example proof manager component that can desirably perform and manage proof generation, including proof generation for larger-scale datasets and distributed proof generation, in accordance with various aspects and embodiments of the disclosed subject matter.

FIG. 3 illustrates a diagram of a non-limiting example proof generation process that can comprise decomposing a graph relating to a workflow into subgraphs, generating subproofs based at least in part on the subgraphs, and generating a proof relating to the workflow based at least in part on the subproofs, in accordance with various aspects and embodiments of the disclosed subject matter.

FIG. 4 depicts a block diagram of a non-limiting example of a linking of two subproofs to each other, in accordance with various aspects and embodiments of the disclosed subject matter.

FIG. 5 illustrates a block diagram of a non-limiting example verifier manager component that can desirably verify proofs relating to datasets received from proof manager components, such as the proof manager component, in accordance with various aspects and embodiments of the disclosed subject matter.

FIG. 6 illustrates a block diagram of a non-limiting example system that can desirably perform and manage proof generation for datasets, comprising performing and managing distributed subproof generation to facilitate the proof generation, in accordance with various aspects and embodiments of the disclosed subject matter.

FIG. 7 depicts a block diagram of a non-limiting example subproof reuse flow that can be performed to facilitate reuse of previously generated subproofs with respect to subsequent subgraphs of subsequent datasets, in accordance with various aspects and embodiments of the disclosed subject matter.

FIG. 8 illustrates a flow chart of an example method that can desirably perform and manage proof generation for a workflow, in accordance with various aspects and embodiments of the disclosed subject matter.

FIG. 9 depicts a flow chart of another example method that can desirably perform and manage proof generation for a workflow, in accordance with various aspects and embodiments of the disclosed subject matter.

FIG. 10 illustrates a flow chart of an example method that can desirably reuse a previously generated subproof associated with a previously processed workflow for use in place of generating a new subproof in connection with processing a subsequent workflow, in accordance with various aspects and embodiments of the disclosed subject matter.

FIG. 11 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, mechanisms, methods, and techniques that desirably (e.g., suitably, accurately, quickly, efficiently, reliably, enhancedly, or optimally) can manage and generate zero-knowledge proofs (ZKPs), including ZKPs for data analytic workflows. Various cryptographic tools can be utilized to protect data. For example, ZKPs can be a cryptographic tool that can enable a prover to convince a verifier of the correctness of computations without revealing the underlying data utilized in performing the computations and generating the ZKP.

There are some existing ZKP systems can involve creating a single ZKP that can encompass an entire computation. For instance, such existing ZKP systems can focus on performing general-purpose computations to create a single ZKP that can encompass an entire computation, which may be a monolithic computation.

However, such approaches, by existing ZKP systems, for creating a single ZKP that can encompass the entire computation often can be deficient, infeasible, inefficient, and/or otherwise undesirable for data analytics workflows, particularly given the significant computational resources that can be utilized to process large datasets to generate the ZKPs. For instance, data analytics workflows often can be modeled as directed acyclic graphs (DAGs), where nodes can represent individual computational steps and edges can represent data dependencies between these computational steps. Generating a single ZKP for a complex data analytics workflow, such as a complex DAG-based workflow, using existing ZKP techniques often can be computationally prohibitive, especially for large-scale data analytics tasks.

It can be desirable (e.g., suitable, beneficial, advantageous, wanted, useful, improved, or optimal) to have a ZKP generation system, method, and technique that can address the challenges of generating ZKPs for data analytics workflows and quickly, efficiently, and accurately generate ZKPs for data analytics workflows. To that end, systems, methods, and techniques that can desirably (e.g., automatically, dynamically, suitably, reliably, efficiently, enhancedly, and/or optimally) address the challenges of generating ZKPs for data analytics workflows and quickly, efficiently, and accurately generate ZKPs for data analytics workflows are presented. In accordance with various embodiments, a system can comprise a proof manager component that can desirably manage and perform generation of proofs (e.g., ZKPs) for workflows (e.g., data analytics workflows, other types of workflows, or other types of datasets).

In some embodiments, the proof manager component can decompose a graph (e.g., a DAG) that can be representative of a workflow (e.g., a data analytics workflow, other type of workflow, or other type of dataset) into respective subgraphs that can be representative of respective portions of the workflow, based at least in part on the results of analyzing the graph, including computational tasks or operations associated with the graph. In certain embodiments, based at least in part on the respective subgraphs, the proof manager component can determine respective subproofs relating to the respective workflow portions and the respective subgraphs (e.g., and respective computational tasks). In some embodiments, the respective subproofs can be concurrently determined and generated using respective servers (e.g., in a distributed manner), which can allow for parallel processing and efficient utilization of computational resources by the system. In certain embodiments, the proof manager component can hash respective input values and respective output values of the respective subgraphs to generate respective hashed input values and respective hashed output values of the respective subgraphs, and can include the respective hashed input values and the respective output values in the respective subproofs associated with the respective subgraphs. The respective hashed input values and the respective output values in the respective subproofs can be utilized to commit to the integrity of the data flow between the respective subgraphs (and accordingly, the respective subproofs).

In some embodiments, the proof manager component can link certain respective subproofs to each other based at least in part on determining that the respective hashed input values or respective hashed output values of the certain respective subproofs satisfy a defined match criterion. For example, the proof manager component can determine that a hashed output value of a first subproof and a hashed input value of a second subproof can satisfy the defined match criterion (e.g., can determine that the hashed output value of the first subproof and the hashed input value of the second subproof match each other, or at least substantially or sufficiently match each other). Based at least in part on determining that the hashed output in value of the first subproof and the hashed input value of the second subproof satisfy the defined match criterion, the proof manager component can determine that the output of the first subproof can be linked to the input of the second subproof. For instance, the proof manager component can link the certain respective subproofs to each other by ensuring that matching hashed input values and hashed output values of subproofs can be consistent across the graph (e.g., the computational DAG).

Based at least in part on the linking of the certain respective subproofs having respective hashed input or hashed output values that satisfy the defined match criterion, the proof manager component can aggregate the respective subproofs to generate the proof (e.g., the ZKP) relating to the workflow, wherein the proof can comprise computation results, which can be derived or obtained from the aggregation of respective computation sub-results of the respective subproofs. For instance, based at least in part on the linking, the proof manager component can aggregate the respective subproofs to generate the proof that can be representative of the correctness of the entire workflow, wherein the proof manager component can perform the aggregation of the respective subproofs by verifying the consistency of the hash commitments between the respective subproofs.

In certain embodiments, the proof manager component can communicate the proof to a verifier (e.g., a verifier component or device) to facilitate verification of correctness of the proof by the verifier, including verification of the computation results of the proof. For instance, the proof can enable the proof manager component to convince the verifier of the correctness (e.g., accuracy) of computations of the proof (and the graph) relating to the workflow without revealing the underlying data of the workflow that was utilized to perform the computations, determine and generate the proof.

In some embodiments, the proof manager component can store the respective subproofs in a data store (e.g., cache memory or other data store) and reuse respective stored subproofs that can relate to respective computations of respective subgraphs of another workflow(s). For example, when another (e.g., a new) workflow is initiated, the proof manager component can analyze the computational tasks of a graph representative of the other workflow (e.g., the respective computational tasks of respective subgraphs of the graph that can be derived from decomposing the graph), and can analyze (e.g., check) the respective computational tasks associated with the respective stored subproofs stored in the data store. If the proof manager component determines that a computational task associated with a stored subproof satisfies a defined similarity criterion (e.g., is same or substantially similar) with respect to the computational task of a subgraph representative of a portion of the other workflow, the proof manager component can determine that the stored subproof can be reused as a subproof with respect to the subgraph associated with the other workflow (e.g., instead of utilizing computational resources to determine and generate a new subproof for the subgraph). The proof manager component, by employing such proof reuse mechanism, can thus allow the system to leverage previously generated subproofs from the data store when identical or similar computational tasks are encountered in subsequent workflows (e.g., data analytics workflows or other types of workflows or datasets). By storing subproofs in the data store and reusing them when desirable to do so, the proof manager component can significantly reduce the amount of time utilized to generate new proofs, especially for recurring computations that can be common in large-scale data analytics. The reuse (e.g., direct reuse) of a stored subproof that is associated with a computational task that is same as (e.g., matches) a computational task of a newly initiated workflow can desirably avoid redundant computations and improve overall efficiency of generation of the proof for the newly initiated workflow and overall efficiency of the system.

The disclosed subject matter, by employing the proof manager component and the enhanced techniques (e.g., enhanced proof generation techniques) described herein, desirably (e.g., automatically, dynamically, suitably, reliably, efficiently, enhancedly, and/or optimally) can distribute portions of the workflow across multiple servers for processing, can reduce the amount of time utilized to process datasets, can reduce and/or avoid redundant computations during the determination and generation of subproofs and proofs, can improve the efficiency of determining and generating proofs, and can improve overall performance of the proof generation system, as compared to existing systems, methods, and techniques for proof generation. The disclosed subject matter, by employing the proof manager component and the enhanced techniques (e.g., enhanced proof generation techniques) described herein, including enhanced techniques for decomposing a graph (e.g., computational DAG) representative of a workflow into smaller respective subgraphs to facilitate generation of respective subproofs, desirably (e.g., automatically, dynamically, suitably, reliably, efficiently, enhancedly, and/or optimally) can make the overall proof generation process significantly more scalable, as each subproof can be generated independently, which can thereby reduce the computational load on individual servers.

The disclosed subject matter, by employing the proof manager component and the enhanced techniques (e.g., enhanced proof generation techniques) described herein, can enable parallelization, as the decomposition of the graph into subgraphs can enable parallel proof generation (e.g., generation of subproofs) across multiple servers, which can enable efficient utilization of distributed computing resources. This can be particularly beneficial for larger-scale data analytics workflows, where different parts (e.g., subgraphs) of the graph can be processed in parallel (e.g., concurrently or simultaneously).

The disclosed subject matter, by employing the proof manager component and the enhanced techniques (e.g., enhanced proof generation techniques) described herein, can enable desirable modularity in the proof generation process, as the proof manager component and the enhanced techniques can provide a modular framework for proof generation, which can enable efficient updates (e.g., incremental updates or other updates) and modifications to individual subproofs without having to regenerate the entire proof or subproof. This modularity also can facilitate enhanced (e.g., improved, better, or optimal) error handling and debugging with regard to generation of proofs.

These and other aspects and embodiments of the disclosed subject matter will now be described with respect to the drawings.

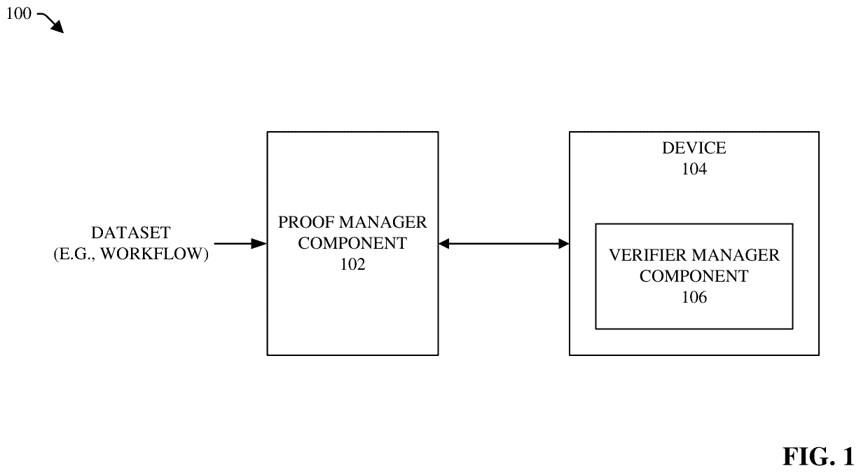

Referring now to the drawings, FIG. 1 illustrates a block diagram of a non-limiting example system 100 that can desirably (e.g., automatically, dynamically, suitably, efficiently, reliably, enhancedly, and/or optimally) perform and manage proof generation for datasets (e.g., data analytics workflows or other types of workflows or datasets), in accordance with various aspects and embodiments of the disclosed subject matter. In some embodiments, the system 100 can comprise a proof manager component 102 that can desirably perform and manage proof (e.g., ZKP) generation, including proof generation for larger-scale datasets (e.g., data analytics workflows) and distributed proof generation.

In accordance with various embodiments, the proof manager component 102 can be part of or associated with (e.g., communicatively connected to) one or more devices (e.g., one or more servers), such as described herein. In certain embodiments, the proof manager component 102 can receive data (e.g., data analytics workflows or other types of workflows or datasets) for processing from one or more devices (not shown in FIG. 1). In some embodiments, the proof manager component 102 can be associated with (e.g., communicatively connected to) a device 104 (e.g., verifier device), which can receive one or more proofs generated by the proof manager component 102 for verification and to obtain computational results, such as described herein. In certain embodiments, the device 104 can comprise a verifier manager component 106 that can verify the proofs, including the computational results, relating to datasets that can be received from the proof manager component 102. It is to be appreciated and understood that, for reasons of brevity and clarity, FIG. 1 depicts only one device 104 (e.g., one verifier device), however, at various times, the proof manager component 102 can be associated with virtually any desired number of verifier devices that can receive proofs from the proof manager component 102 for verification and to obtain computational results. It also is to be appreciated and understood that, while various embodiments of the disclosed subject matter described herein relate to data analytics workflows, the techniques and embodiments of the disclosed subject matter relating to proof generation can be utilized or applied to virtually any type of dataset or workflow, including relatively larger or relatively smaller datasets or workflows.

In accordance with various embodiments, a device (e.g., the one or more devices comprising or associated with the proof manager component 102, the device 104, or other device) can be a computer, a laptop computer, a server, a wireless, mobile, or smart phone, an electronic pad or tablet, a VA device, electronic eyewear, an electronic watch, or other electronic bodywear, an electronic gaming device, an Internet of Things (IOT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term user equipment (UE) can be used to describe the device.

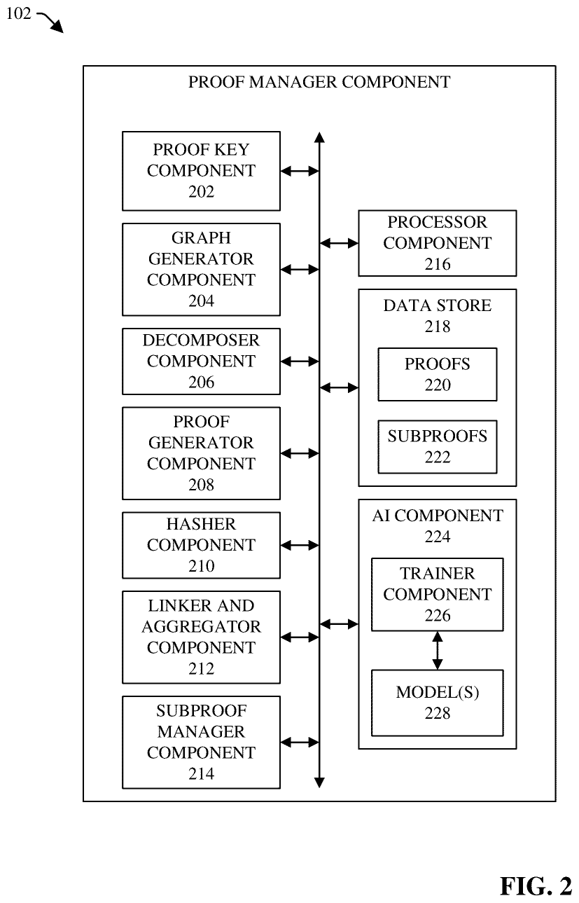

Referring to FIG. 2 (along with FIG. 1), FIG. 2 depicts a block diagram of a non-limiting example proof manager component 102 that can desirably (e.g., automatically, dynamically, suitably, reliably, efficiently, enhancedly, and/or optimally) perform and manage proof (e.g., ZKP) generation, including proof generation for larger-scale datasets (e.g., data analytics workflows) and distributed proof generation, in accordance with various aspects and embodiments of the disclosed subject matter. In accordance with various embodiments, the proof manager component 102 can comprise a proof key component 202, a graph generator component 204, a decomposer component 206, a proof generator component 208, a hasher component 210, a linker and aggregator component 212, and a subproof manager component 214. In certain embodiments, the proof manager component 102 can comprise (as depicted) or be associated with (e.g., communicatively connected to) a processor component 216 and a data store 218. In some embodiments, the proof manager component 102 can store proofs 220 and subproofs 222 relating to datasets, and other desired data, in the data store 218, such as described herein. In accordance with various embodiments, the proof manager component 102 can comprise or can be associated with an artificial intelligence (AI) component 224, which can comprise a trainer component 226 and one or more models 228 (e.g., AI-based models).

In some embodiments, the proof manager component 102 can receive a dataset from another device or can retrieve the dataset (e.g., a previously received and stored dataset) from the data store 218. The dataset can be a data analytics workflow or other type of workflow or dataset. In certain embodiments, the graph generator component 204 can determine and generate a graph (e.g., a DAG or other desired type of graph) that can be representative of the dataset, based at least in part on the results of analyzing the data of the dataset. In some embodiments, the graph can comprise a group of nodes where respective nodes can be associated with (e.g., connected to) respective other nodes of the node group via respective edges (e.g., connectors), wherein the respective edges can have respective data dependencies, depending in part on the dataset. For instance, a first node can have an edge associated with its output, and the other end of the edge can be associated with an input of a second node, wherein data output from the first node can be communicated, via the edge, to the input of the second node. The respective nodes of the node group can be representative of or associated with respective computational tasks or operations that can be performed within the graph (e.g., by the proof manager component 102) on respective portions of the dataset, and/or on data generated by other nodes of the node group, to determine and generate the proof, including computational results, based at least in part on the results of analyzing the dataset.

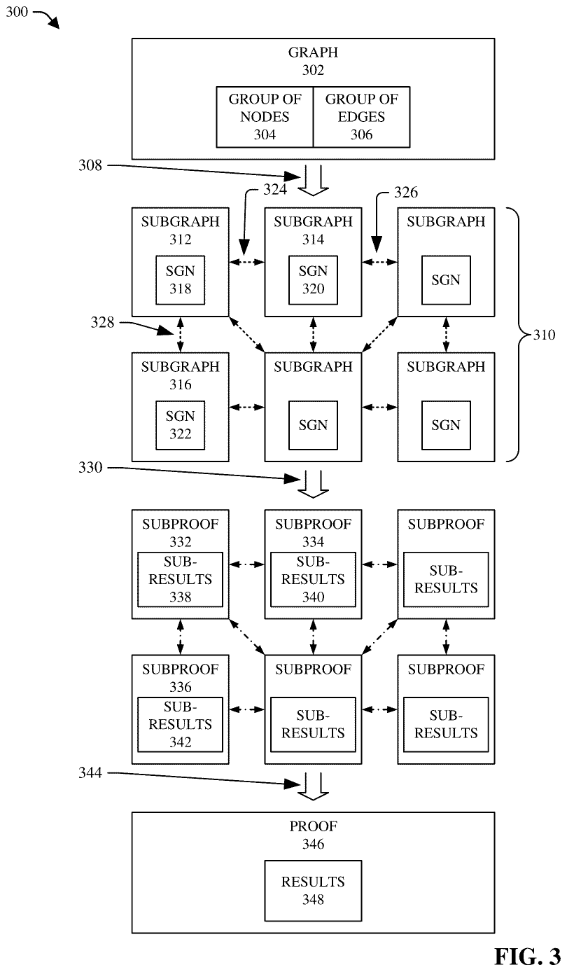

Referring to FIG. 3 (along with FIGS. 1 and 2), FIG. 3 illustrates a diagram of a non-limiting example proof generation process 300 that can comprise decomposing a graph relating to a workflow into subgraphs, generating subproofs based at least in part on the subgraphs, and generating a proof relating to the workflow based at least in part on the subproofs, in accordance with various aspects and embodiments of the disclosed subject matter. In accordance with various embodiments, the graph generator component 204 can determine and generate the graph 302 (e.g., a DAG or other desired type of graph) that can be representative of or related to the workflow (e.g., data analytics workflow or other type of workflow), based at least in part on the results of analyzing the data of the workflow. The graph 302 can comprise a group of nodes 304 and a group of edges 306, wherein respective edges of the edge group 306 can connect respective outputs of respective nodes of the node group 304 with respective inputs of other respective nodes of the node group 304. The respective edges can have respective data dependencies between the respective nodes and the respective computational tasks associated with the respective nodes, depending in part on the workflow. For example, the data expected or desired at an input of a second node can be dependent in part on data output from a first node, wherein the edge between the output of the first node and the input of the second node can comprise such data dependency. The respective nodes of the node group 304 can be representative of or associated with respective computational tasks or operations that can be performed within the graph 302 (e.g., by the proof manager component 102) on respective portions of the workflow, and/or on data generated by other nodes of the node group 304, to determine and generate the proof (e.g., ZKP), including computational results, relating to the dataflow based at least in part on the results of analyzing the workflow.

In some embodiments, the decomposer component 206 can perform a graph decomposition process 308 to decompose (e.g., segment, divide, partition, or separate) the graph 302 into a group of subgraphs 310, comprising subgraph 312, subgraph 314, and subgraph 316, based at least in part on the results of analyzing the graph 302 and/or the workflow. The decomposer component 206 can decompose the graph 302 into respective subgraphs (e.g., 312, 314, 316) of the group of subgraphs 310 such that each of the respective subgraphs (e.g., 312, 314, 316) can comprise, relate to, or be representative of one or more respective portions of the workflow comprising one or more respective computational tasks relating to the workflow. In certain embodiments, the respective subgraphs (e.g., 312, 314, 316) of the subgraph group 310 each can comprise respective subgroups of nodes (SGNs), which can comprise subgroup of nodes 318 of the subgraph 312, subgroup of nodes 320 of the subgraph 314, and subgroup of nodes 322 of the subgraph 316, wherein the respective subgroups of nodes (e.g., 318, 320, 322) each can comprise one or more respective nodes that can relate to or be representative of one or more respective computational tasks, based at least in part on (e.g., in accordance with) the workflow. In some embodiments, there can be respective edges, comprising edge 324, edge 326, and edge 328, that can be associated with (e.g., connected to) and situated between the respective subgraphs (e.g., 312, 314, 316), and accordingly, the respective subgroups of nodes (e.g., 318, 320, 322), wherein the respective edges (e.g., 324, 326, 328) can have respective data dependencies, such as described herein. It is to be appreciated and understood that the number of subgraphs generated from decomposing a graph relating to a workflow, the number of edges between the subgraphs, the arrangement of the subgraphs, and the arrangement of the edges in relation to the subgraphs, can vary depending on, and can be based at least in part on, the graph and/or the workflow. It also is to be appreciated and understood that the edges (e.g., 324, 326, 328) depicted with regard to the group of subgraphs 310 is merely a non-limiting example of edges, and the arrangement of the edges can be different than depicted in FIG. 3, depending in part on the workflow. For instance, depending in part on the workflow, instead of, or in addition to, there being the edge 324 between the output of the subgraph 312 and the input of the subgraph 314, there can be an edge between the output of the subgraph 312 and another input of another subgraph of the group of subgraphs 310.

In certain embodiments, the proof generator component 208 can perform a subproof generation process 330, wherein the proof generator component 208 can determine and generate, or can facilitate determining and generating, respective subproofs (e.g., respective zero knowledge subproofs), comprising subproof 332, subproof 334, and subproof 336, based at least in part on the respective subgraphs (e.g., 312, 314, 316) of the subgraph group 310. For instance, the proof generator component 208 can determine and generate, or can facilitate determining and generating, subproof 332, comprising sub-results 338 (e.g., computational sub-results), based at least in part on the subgraph 312 and/or a cryptographic key (e.g., a private and/or secure encryption key) of the proof key component 202, wherein the proof generator component 208 can perform the one or more computational tasks within the subgraph 312, using (e.g., by analyzing and performing computational operations on) a portion of data associated with the workflow, to determine and generate the sub-results 338. In some embodiments, the sub-results 338 can be cryptographically secured (e.g., encrypted) using the cryptographic key of the proof key component 202. In other embodiments, the proof manager component 102 can cryptographically secure (e.g., encrypt) the final computational results of the proof using the cryptographic key of the proof key component 202 after the proof generator component 208 has determined and generated the proof based at least in part on the respective subproofs (e.g., 332, 334, 336). In some embodiments, the proof key component 202 can determine, generate, utilize, and/or provide different cryptographic keys for use in determining and generating different proofs for different datasets (e.g., data analytics workflows or other datasets). In certain embodiments, similar to the determination and generation of the subproof 332, the proof generator component 208 can determine and generate, or can facilitate determining and generating, the other respective subproofs (e.g., 334, 336), comprising other respective sub-results (e.g., 340, 342), based at least in part on the other respective subgraphs (e.g., 314, 316) and/or the cryptographic key, wherein the proof generator component 208 (or another proof generator component(s) associated with another server(s)) can perform the one or more respective computational tasks within the other respective subgraphs (e.g., 314, 316), using (e.g., by analyzing and performing respective computational operations on) other respective portions of data associated with the workflow, to determine and generate the other respective sub-results (e.g., 340, 342). The respective subproofs (e.g., 332, 334, 336) capture and/or represent the correctness (e.g., accuracy) of the respective computations performed within the respective subgraphs (e.g., 312, 314, 316) of the subgraph group 310 by the proof generator component 208.

In accordance with various embodiments, one or more servers (e.g., employing one or more respective proof manager components) can determine and generate the respective subproofs (e.g., 332, 334, 336), comprising the respective sub-results (e.g., 338, 340, 342), based at least in part on the respective subgraphs (e.g., 312, 314, 316), the data of or associated with (e.g., derived, calculated, or obtained from or in connection with) the workflow, and/or the cryptographic key. For instance, a first server (e.g., employing proof manager component 102) can determine and generate the subproof 332, based at least in part on the subgraph 312 and a first portion of the data of or associated with the workflow, a second server (e.g., employing another proof manager component) can determine and generate the subproof 334, based at least in part on the subgraph 314 and a second portion of the data of or associated with the workflow, and/or another server (e.g., employing still another proof manager component) can determine and generate the subproof 336, based at least in part on the subgraph 316 and another portion of the data of or associated with the workflow, in parallel (e.g., concurrently, simultaneously, or substantially simultaneously, in a distributed manner), such as described herein.

Based at least in part on (e.g., in accordance with) the respective data dependencies and the respective sub-results (e.g., 338, 340, 342) associated with the respective subproofs (e.g., 332, 334, 336), the respective subproofs (e.g., 332, 334, 336) can have respective input values and respective output values. In some embodiments, the hasher component 210 can hash the respective input values and the respective output values of the respective subproofs (e.g., 332, 334, 336) to determine and generate respective hashed input values and respective hashed output values of the respective subproofs (e.g., 332, 334, 336), based at least in part on (e.g., utilizing and in accordance with) a desired hashing algorithm or technique and/or the cryptographic key (e.g., the private encryption key) of the proof key component 202. For instance, the hasher component 210 can hash a first input value(s) and a first output value(s) of the first subproof (e.g., 332) to determine and generate a first hashed input value(s) and a first hashed output value(s) of the first subproof, hash a second input value(s) and a second output value(s) of the second subproof (e.g., 334) to determine and generate a second hashed input value(s) and a second hashed output value(s) of the second subproof, and/or hash another input value(s) and another output value(s) of another subproof (e.g., 336) to determine and generate another hashed input value(s) and another hashed output value(s) of the other subproof, based at least in part on the desired hashing algorithm or technique and/or the cryptographic key.

In certain embodiments, the proof manager component 102 can utilize the respective hashed input values and the respective hashed output values of the respective subproofs (e.g., 332, 334, 336) to commit to the integrity of the data flow between the respective subgraphs (e.g., 312, 314, 316) associated with the respective subproofs (e.g., 332, 334, 336) to facilitate ensuring and/or maintaining the integrity of the entire workflow. For instance, the integrity of the entire workflow can be ensured and maintained by committing to the respective hashed input values and the respective hashed output values of the respective subproofs (e.g., 332, 334, 336) relating to the workflow. Committing to the hashed input and output values of the subproofs can refer to cryptographically binding these hashed values to ensure the integrity and verifiability of the data flow between subproofs within the workflow. For instance, consider a sequence of workloads, w₁, w₂, w₃, and so on, of a workflow with corresponding subproofs p₁, p₂, p₃, and so on. In some embodiments, instead of generating a full proof for the workloads (e.g., w₁, w₂, w₃, and so on) to ensure the integrity of the entire workflow, the proof manager component 102 can generate respective subproofs (e.g., p₁, p₂, p₃, and so on) for respective portions (e.g., respective steps) of the workflow, with the overall integrity of the workflow ensured by binding (e.g., linking, joining, or constraining) the hashed output value of the output of subproof p₁ with the hashed input value of the input of subproof p₂, binding the hashed output value of the output of subproof p₂ with the hashed input value of the input of subproof p₃, and so on.

In accordance with various embodiments, the proof manager component 102 can perform a proof generation process 344 to determine and generate a proof 346, comprising results 348 (e.g., computational results) based at least in part on the respective subproofs (e.g., 332, 334, 336), comprising the respective sub-results (e.g., 338, 340, 342). In certain embodiments, the linker and aggregator component 212 (e.g., in conjunction with the proof generator component 208) can respectively link respective subproofs (e.g., the respective subproofs 332, 334, and/or 336) to other of the respective subproofs (e.g., other of the respective subproofs 332, 334, and/or 336), and can aggregate the respectively linked subproofs to determine and generate the proof 346, comprising the results 348 (e.g., overall or final computational results), based at least in part on the respective hashed input values and the respective hashed output values of the respective subproofs (e.g., 332, 334, 336) relating to the workflow, and a defined match criterion relating to matching of hashed values. For instance, the linker and aggregator component 212 can analyze the respective hashed input values and the respective hashed output values of the respective subproofs (e.g., 332, 334, 336), and, based at least in part on the results of such analysis, can determine respective hashed output values of certain respective subproofs (e.g., subproof 332) that satisfy (e.g., meet) the defined match criterion with respect to respective hashed input values of certain other respective subproofs (e.g., subproof 334). In some embodiments of the described system 100, the proof manager component 102 can link the subproofs through a process that can involve matching the hashed output values of one subproof with the hashed input values of another subproof with respect to the subproofs associated with the workflow. This matching mechanism employed by the proof manager component 102 can ensure the integrity of the workflow by enforcing a cryptographic binding between consecutive computational steps (e.g., consecutive computational operations) of the workflow. In certain embodiments, each subproof associated with the workflow can correspond to a specific computation or transformation applied to the data. When a subproof produces an output, the proof manager component 102 (e.g., employing the hasher component 210) can hash the result (e.g., hash the output value or sub-result) to create a unique, verifiable “fingerprint” (e.g., unique, verifiable identifier or characteristic) that can be utilized to identify the result of the subproof. If another subproof associated with the workflow desires (e.g., wants or requires; and/or is to utilize) this output data as its input data, this other subproof can reference the same hashed value. The matching of these respective hashed output and input values can confirm that the expected and desired data flow is preserved, thereby allowing those subproofs to be securely linked.

As a non-limiting example of using and linking subproofs in a data analytics pipeline, consider a data analytics workflow where raw data can first be filtered based on a specific condition to generate a filtered dataset, and the filtered dataset can be used as input to train a machine learning model. The process can involve, for example, the following operations or steps:

Step 1: Data Filtering (Subproof 1 (p₁))
a) a dataset containing customer transactions can be filtered to only include purchases above $100 to generate a filtered dataset; and
b) the resulting filtered dataset (D′) can be hashed (e.g., by the hasher component 212) to product a hash (Output p₁).
   Step 2: Machine Learning Model Training (Subproof 2 (p₂))
a) the filtered dataset (D′) can be used as input to train a customer segmentation model (e.g., machine learning model relating to customer segmentation);
b) before using the filtered dataset (D′) as input, the proof manager component 102 can verify that the hash (Output p₁) of subproof p₁ matches (e.g., satisfies the defined match criterion) the expected hashed input, hash (Input p₂), of subproof p₂; and
c) if the hashed output (e.g., the filtered dataset), hash (Output p₁), is determined (e.g., by the proof manager component 102) to match the expected hashed input, hash (Input p₂), of subproof p₂, the proof manager component 102 can confirm that the correct data (e.g., the filtered dataset) is being used for training of the customer segmentation model, and the output of the subproof p₁ can be linked to the input of subproof p₂.

In some embodiments, based at least in part on (e.g., as a result of or in response to) the linker and aggregator component 212 determining that the respective hashed output values of the certain respective subproofs can satisfy the defined match criterion with respect to the respective hashed input values of the certain other respective subproofs, the linker and aggregator component 212 can link the respective outputs of the certain respective subproofs to the respective inputs of the certain other respective subproofs via respective links to aggregate the respective subproofs (e.g., 332, 334, 336) to facilitate generating the proof 346 comprising the respectively linked and aggregated subproofs. For instance, the linker and aggregator component 212 can link the respective outputs of the certain respective subproofs to the respective inputs of the certain other respective subproofs by ensuring that the respectively matching hashed input values and hashed output values of the respective subproofs can be consistent across the graph 302 (e.g., the computational DAG). In certain embodiments, as part of the linking and aggregating of the certain respective subproofs to the certain other respective subproofs, the linker and aggregator component 212 can check (e.g., evaluate) the consistency of the respective hash commitments between the certain respective subproofs and the certain other respective subproofs. In some embodiments, the respective links between the respective outputs of the certain respective subproofs to the respective inputs of the certain other respective subproofs can enable the respective output data (e.g., respective computational sub-results) of the certain respective subproofs to flow (e.g., be communicated to) the respective inputs of the certain other respective subproofs to facilitate generation of the proof based at least in part on the respective subproofs (e.g., 332, 334, 336). The proof 346 can comprise the results 348 (e.g., computational results), and can represent the correctness (e.g., accuracy) of the entire workflow (e.g., as represented by the graph 302).

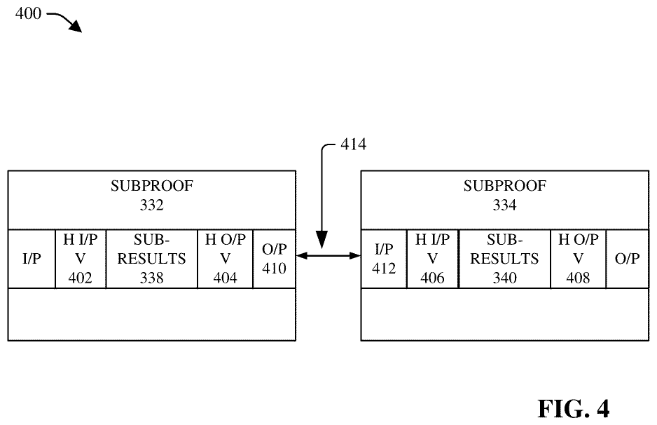

Referring briefly to FIG. 4 (along with FIGS. 1-3), FIG. 4 depicts a block diagram of a non-limiting example of a linking 400 of two subproofs to each other, in accordance with various aspects and embodiments of the disclosed subject matter. In some embodiments, the subproof 332 can have a hashed input value (H I/P V) 402 and a hashed output value (H O/P V) 404, and the subproof 334 can have a hashed input value 406 and a hashed output value 408, wherein the hashed output value 404 of the subproof 332 can match (e.g., can be the same as) the hashed input value 406 of the subproof 334. In certain embodiments (e.g., in an example scenario), based at least in part on the results of the analysis of the respective hashed input values and the respective hashed output values of the respective subproofs (e.g., 332, 334, 336), the linker and aggregator component 212 can determine that the hashed output value 404 of the subproof 332 can satisfy the defined match criterion (e.g., can match) with respect to the hashed input value 406 of the subproof 334. Based at least in part on (e.g., as a result of or in response to) determining that the hashed output value 404 of the subproof 332 can satisfy the defined match criterion with respect to the hashed input value 406 of the subproof 334, the linker and aggregator component 212 can link the output (O/P) 410 of the subproof 332 to the input (I/P) 412 of the subproof 334 via a link 414.

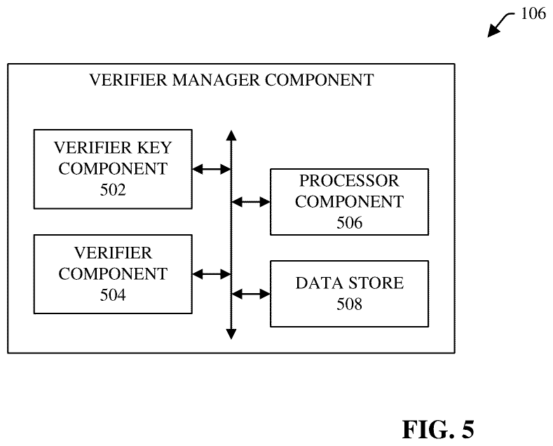

In some embodiments, the proof manager component 102 can communicate the proof 346 (e.g., the ZKP), comprising the results 348, to the device 104 (e.g., the verifier device) for verification and to obtain and/or utilize (e.g., further process or otherwise utilize) the results 348. Turning to FIG. 5 (along with FIGS. 1-3), FIG. 5 illustrates a block diagram of a non-limiting example verifier manager component 106 that can desirably (e.g., automatically, dynamically, suitably, efficiently, reliably, enhancedly, and/or optimally) verify proofs relating to datasets (e.g., workflows, such as data analytics workflows) received from proof manager components, such as the proof manager component 102, in accordance with various aspects and embodiments of the disclosed subject matter. In some embodiments, the verifier manager component 106 can comprise a verifier key component 502 and a verifier component 504. In certain embodiments, the verifier manager component 106 can comprise or be associated with a processor component 506 and a data store 508.

In certain embodiments, the verifier component 504 can verify the correctness of received proofs, such as the proof 346, including verification of the results (e.g., computational results) of the proofs, such as the results 348, based at least in part on the results of analyzing (e.g., evaluating) the proofs. In some embodiments, the proof 346, including the results 348, can be secured (e.g., encrypted using the cryptographic key of the proof key component 202 of the proof manager component 102). In accordance with such embodiments, the verifier component 504 can utilize a cryptographic key (e.g., a decryption key, which can be a public decryption key) of the verifier key component 502 that can decrypt the information (e.g., encrypted information) of the proof 346 and facilitate verification of the proof 346, including the results 348. In certain embodiments, the decryption key can correspond to, can be consistent with, and/or can be determined and generated based at least in part on the encryption key (e.g., of the proof key component 202 of the proof manager component 102) that was used to determine and generate the proof 346. Based at least in part on the results of analyzing the proof 346 and/or the decryption of the proof 346, the verifier component 504 can verify the correctness of the proof 346, including verification of the results 348 of the proof 346. For instance, the proof 346 can enable the proof manager component 102 to convince the verifier component 504 of the correctness (e.g., accuracy) of the computations (e.g., underlying computations), and the results 348 (e.g., results that can be accessible to the verifier component 504), of the proof 346 relating to the workflow without revealing (e.g., by preventing, inhibiting, and/or not allowing the revealing of) the underlying data (e.g., private, secure, and/or proprietary data) of the workflow that was utilized (e.g., by the proof manager component 102) to perform the computations and determine and generate the proof 346. That is, the verifier component 504, by successfully verifying the proof 346, including the results 348, can have confidence that the proof 346, including the results 348 and the underlying computations, are correct, even though the verifier component 504 may not be able to access the underlying data of the workflow to independently verify the proof 346, including the results 348 and the underlying computations, utilizing the underlying data of the workflow.

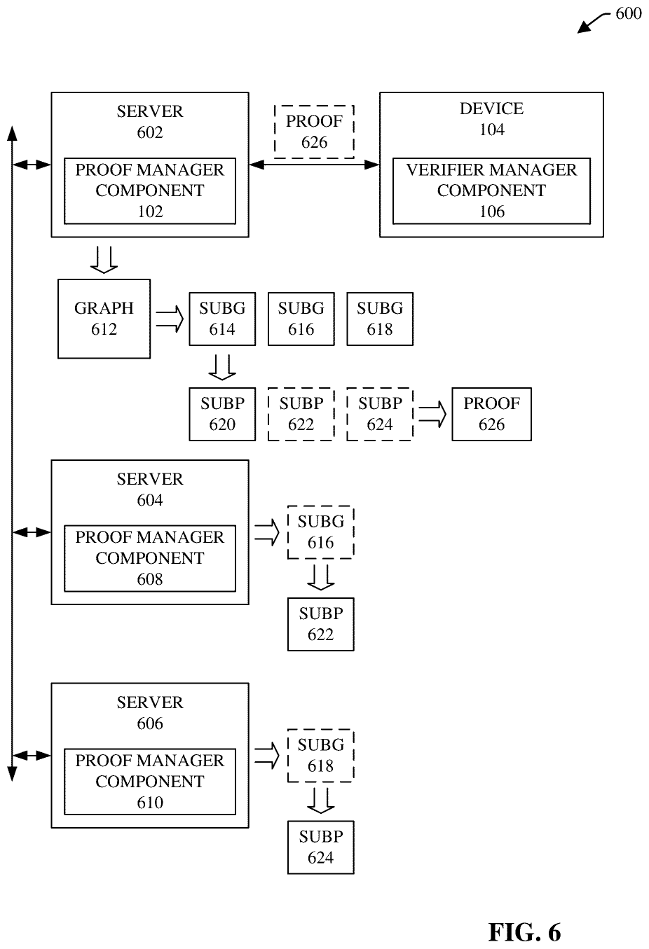

Referring to FIG. 6 (along with FIGS. 1-3), FIG. 6 illustrates a block diagram of a non-limiting example system 600 that can desirably (e.g., automatically, dynamically, suitably, efficiently, reliably, enhancedly, and/or optimally) perform and manage proof generation for datasets (e.g., data analytics workflows or other types of workflows or datasets), comprising performing and managing distributed subproof generation to facilitate the proof generation, in accordance with various aspects and embodiments of the disclosed subject matter. In some embodiments, the system 600 can comprise a desired number of servers, including server 602, server 604, and/or server 606, that can be associated with each other (e.g., communicatively connected or networked to each other). In certain embodiments, the respective servers (e.g., 602, 604, and/or 606) can comprise respective proof manager components, such as the proof manager component 102, a proof manager component 608, and/or a proof manager component 610, wherein the respective proof manager components (e.g., 608 and/or 610) can comprise the same or similar components, and/or can have the same or similar functionality as, the proof manager component 102, such as described herein.

In some embodiments, the proof manager component 102 (e.g., employing the graph generator component 204) can determine and generate a graph 612 (e.g., a DAG or other desired type of graph) that can be representative of a dataset (e.g., data analytics flow or other dataset), based at least in part on the results of analyzing data of the dataset, such as described herein. In certain embodiments, the proof manager component 102 (e.g., employing the decomposer component 206) can perform the graph decomposition process (e.g., 308) to decompose the graph 612 into a group of subgraphs, which can comprise subgraph (SUBG) 614, subgraph 616, and/or subgraph 618, based at least in part on the results of analyzing the graph 612 and/or the dataset, such as described herein. For instance, the decomposer component 206 can decompose the graph 612 into respective subgraphs (e.g., 614, 616, and/or 618) of the group of subgraphs such that each of the respective subgraphs (e.g., 614, 616, and/or 618) can comprise, relate to, or be representative of one or more respective portions of the dataset comprising one or more respective computational tasks relating to the dataset.

In some embodiments, the proof manager component 102 (e.g., employing the subproof manager component 214) can distribute and communicate some of the respective subgraphs representative of some portions of the data set to other servers for respective processing (e.g., parallel, concurrent, or simultaneous processing) of those respective subgraphs by the other servers. For instance, the proof manager component 102 (e.g., employing the subproof manager component 214) can distribute and communicate the subgraph 616 to the server 604 and the subgraph 618 to the server 606 for respective processing.

In certain embodiments, the server 602, employing the proof manager component 102 (e.g., employing the proof generator component 208), can perform the subproof generation process (e.g., 330) to determine and generate, or can facilitate determining and generating, a subproof (SUBP) 620 (e.g., a zero knowledge subproof), comprising sub-results (e.g., computational sub-results), based at least in part on the subgraph 614, such as described herein. In some embodiments, similarly, and in parallel (e.g., concurrently), the server 604, employing the proof manager component 608 (e.g., employing its proof generator component), can perform the subproof generation process to determine and generate, or can facilitate determining and generating, a subproof 622 (e.g., a zero knowledge subproof), comprising sub-results, based at least in part on the subgraph 616, and/or the server 606, employing the proof manager component 610 (e.g., employing its proof generator component), can perform the subproof generation process to determine and generate, or can facilitate determining and generating, a subproof 624 (e.g., a zero knowledge subproof), comprising sub-results, based at least in part on the subgraph 618, such as described herein.

In accordance with various embodiments, the server 602, employing the proof manager component 102 (e.g., employing the hasher component 210) can hash an input value and output value of the subproof 620 to determine and generate a hashed input value and hashed output value of the subproof 620, based at least in part on the sub-results of the subproof 620 and the desired hashing algorithm or technique; the server 604, employing the proof manager component 608 (e.g., employing its hasher component) can hash an input value and output value of the subproof 622 to determine and generate a hashed input value and hashed output value of the subproof 622, based at least in part on the sub-results of the subproof 622 and the desired hashing algorithm or technique; and/or the server 606, employing the proof manager component 610 (e.g., employing its hasher component) can hash an input value and output value of the subproof 624 to determine and generate a hashed input value and hashed output value of the subproof 624, based at least in part on the sub-results of the subproof 624 and the desired hashing algorithm or technique (e.g., in parallel, concurrently, or simultaneously), such as described herein.

In certain embodiments, the server 604 (e.g., employing the proof manager component 608) can communicate the subproof 622, comprising sub-results and/or the hashed input and output values, to the server 602, the server 606 (e.g., employing the proof manager component 610) can communicate the subproof 624, comprising sub-results and/or the hashed input and output values, to the server 602, and/or another server can communicate another subproof, comprising sub-results and/or the hashed input and output values, generated using that other server, to the server 602. The proof manager component 102 (e.g., employing the proof generator component 208 and/or the linker and aggregator component 212) can link and aggregate the respective subproofs (e.g., 620, 622, 624) to determine and generate a proof 626, comprising results (e.g., computational results), based at least in part on the respective sub-results, and the respective hashed input and output values, of the respective subproofs (e.g., 620, 622, 624), such as described herein. The server 602 can communicate the proof 626 (e.g., the ZKP), comprising the results, to the device 104 (e.g., the verifier device) for verification and to obtain and/or utilize (e.g., further process or otherwise utilize) the results, such as described herein.

With further regard to FIGS. 1 and 2, in accordance with various embodiments, the proof manager component 102, employing the subproof manager component 214, can reuse one or more previously generated subproofs 222 (e.g., previously generated subproofs that can be matching or similar subproofs), in place of generating one or more subproofs relating to a dataset, to facilitate generating (e.g., efficiently and/or optimally determining and generating) a proof relating to the dataset. In some embodiments, the subproof manager component 214 can comprise a subproof reuse mechanism that can allow the proof manager component 102 to leverage previously generated subproofs 222 from a subproof cache of the data store 218 when computational tasks of a subgraph of a subsequent dataset (e.g., a subsequent data analytics workflow that is being processed) are determined to be identical or similar to computational tasks that were performed in connection with generation of the previously generated subproof 222.

For instance, if it can be assumed that input data typically can remain invariant across different workflows, this can allow and/or enable the proof manager component 102 to decompose a workflow and reuse subproofs for same operations (e.g., same or identical operational steps) from previous workflows. For example, consider two workflows, w₁ and w₂, wherein workflow w₁ can be comprised of subproofs p₁, p₂, and p₃:

$${w}_{1} = {p}_{3} ( {p}_{2} ( {p}_{1} ( data ) )$$

$${w}_{2} = {p}_{4} ( {p}_{2} ( {p}_{1} ( data ) ) .$$

When generating the proof for workflow w₂ (which can comprise subproof p₄), the proof manager component 102 (e.g., employing the subproof manager component 214) can reuse the subproofs of p₁(data) and p₂(p₁(data)) from workflow w₁. In some embodiments, in more general cases, the proof manager component 102 can represent workflows as DAGs, and can eagerly match shared prefixes to enhance (e.g., maximize or optimize) subproof reuse.

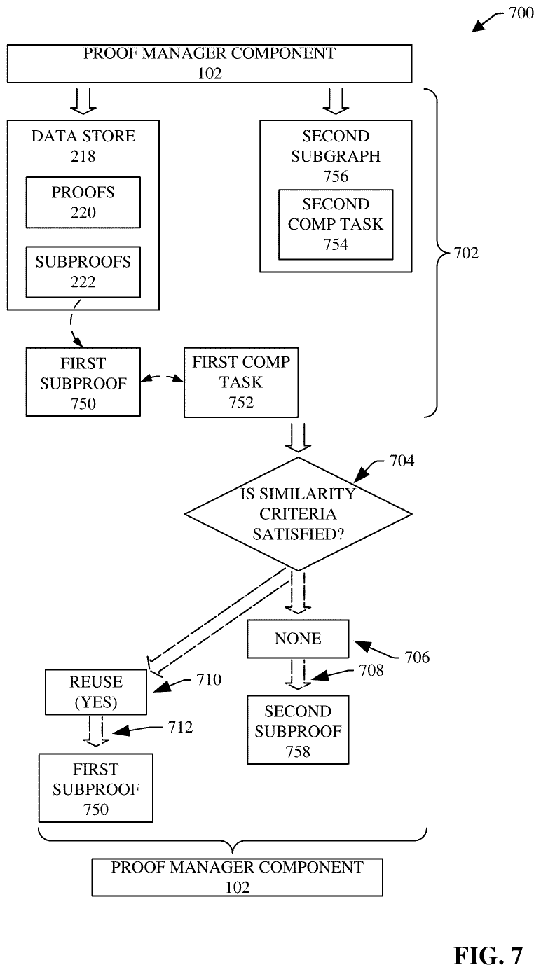

Referring to FIG. 7 (along with FIGS. 1 and 2), FIG. 7 depicts a block diagram of a non-limiting example subproof reuse flow 700 that can be performed to facilitate reuse of previously generated subproofs with respect to subsequent subgraphs of subsequent datasets, in accordance with various aspects and embodiments of the disclosed subject matter. In some embodiments, as described herein, the proof manager component 102 (e.g., employing the subproof manager component 214) can store, in the data store 218 (e.g., subproof cache of the data store 218), respective previously generated subproofs (e.g., 222) associated with the one or more previously generated proofs (e.g., 220) associated with one or more previously processed datasets to facilitate reuse of one or more of the respective previously generated subproofs with regard to subsequent datasets (e.g., subsequent data analytics workflows or other subsequent datasets). The previously generated subproofs (e.g., 222) can comprise, for example, a first subproof 750 that can relate to a first computational task (FIRST COMP TASK) 752 which was performed within a first subgraph relating to a previous workflow, wherein the first subgraph can be representative of a portion of the previous workflow (and a portion of a first graph representative of the previous workflow).

In certain embodiments, with regard to a subsequent workflow, the proof manager component 102 (e.g., employing the subproof manager component 214) can determine whether to reuse a previously generated and stored subproof in place of (e.g., in lieu of, or instead of) utilizing time and computational resources to perform a second computational task (SECOND COMP TASK) 754 associated with a second subgraph 756 associated with a second graph that can be representative of the subsequent workflow (e.g., in accordance with the example subproof reuse flow 700). The second subgraph 756 can be derived (e.g., by the proof manager component 102) from decomposing the second graph into a group of subgraphs, comprising the second subgraph 756, such as described herein. In some embodiments, as indicated at reference numeral 702 of the example subproof reuse flow 700, in connection with processing the subsequent workflow, the proof manager component 102 (e.g., employing the subproof manager component 214) can evaluate (e.g., analyze or check) the respective computational tasks associated with the respective previously generated subproofs (e.g., 222) stored in the data store 218 and the second computational task 754 associated with the second subgraph 756 associated with (e.g., representative of a portion of) the subsequent workflow to facilitate determining whether any of the respective computational tasks associated with the respective previously generated subproofs satisfy the defined similarity criteria with respect to the second computational task 754. For instance, the subproof manager component 214 can evaluate the relative sameness or similarities (if any) between the respective computational tasks associated with the respective previously generated subproofs (e.g., 222) and the second computational task 754 associated with the second subgraph 756 associated with the subsequent workflow. It is to be appreciated and understood that, while in some instances, the second computational task 754 can comprise one computational task, in other instances, the second computational task 754 can comprise more than one computational task (e.g., a group of computational tasks).

In some embodiments, as indicated at reference numeral 704 of the example subproof reuse flow 700, based at least in part on the results of such evaluation, the proof manager component 102 (e.g., employing the subproof manager component 214) can determine whether any of the respective computational tasks associated with the respective previously generated subproofs (e.g., 222) satisfy the defined similarity criteria (e.g., for reuse) with respect to the second computational task 754 associated with the subsequent workflow.

As indicated at reference numeral 706 of the example subproof reuse flow 700, in some embodiments, if, based at least in part on the evaluation results, the proof manager component 102 (e.g., employing the subproof manager component 214) determines that none of the respective computational tasks associated with the respective previously generated subproofs (e.g., 222) satisfy (e.g., meet or comply with) the defined similarity criteria with respect to the second computational task 754 associated with the second subgraph 756 of the subsequent workflow, the proof manager component 102 can determine that none of the respective previously generated subproofs (e.g., 222) can be reused with respect to the second computational task 754 in place of generating a second (e.g., a new) subproof as part of processing the subsequent workflow. Accordingly, as indicated at reference numeral 708 of the example subproof reuse flow 700, the proof manager component 102 can generate the second subproof 758 based at least in part on the second subgraph 756, wherein, as part of generating the second subproof 758, the proof manager component 102 can perform the second computational task 754 within the second subgraph 756, such as described herein.

As indicated at reference numeral 710 of the example subproof reuse flow 700, in certain embodiments, if, instead, based at least in part on the evaluation results, the proof manager component 102 (e.g., employing the subproof manager component 214) determines that the first computational task 752 associated with the first subproof 750, of the respective previously generated subproofs (e.g., 222), satisfies the defined similarity criteria for reuse with respect to the second computational task (e.g., the first computational task 752 is determined to be same or substantially same as the second computational task 754), the proof manager component 102 can determine that the first subproof 750, including the first computational sub-results, can be reused in place of performing the second computational task 754 and generating the second subproof 758 as part of processing of the subsequent workflow. Accordingly, as indicated at reference numeral 712 of the example subproof reuse flow 700, the proof manager component 102 can reuse the first subproof 750, including the first computational sub-results from the performance of the first computational task 752, in place of generating the second subproof 758, instead of undesirably utilizing time and computational resources to perform the second computational task 754 within the second subgraph 756 relating to the subsequent workflow and generate the second subproof 758. The first computational sub-results can be the same or substantially the same as the second computational sub-results that would have been obtained had the proof manager component 102 performed the second computational task 754 within the second subgraph 756 and generated the second subproof 758. In some embodiments, the proof manager component 102 can update and/or modify the first subproof 750, as desired (e.g., as wanted, suitable, appropriate, or needed) to account for any particular and/or minor differences between the first computational task 752 and the second computational task 754.

The disclosed subject matter (e.g., the proof manager component and the enhanced techniques described herein), by storing the subproofs 222 in the subproof cache of the data store 218, and reusing those subproofs 222 when computational tasks of those subproofs 222 are determined to match or be similar to subsequent computational tasks associated with subsequent subgraphs associated with subsequent datasets, instead of performing those subsequent computational tasks anew to generate subsequent (e.g., new and/or redundant) subproofs, can desirably and significantly reduce the amount of time utilized to process datasets (e.g., by avoiding the amount of time utilized to determine and generate new subproofs and associated proofs, when stored subproofs 222 can be reused), can reduce and/or avoid redundant computations during the determination and generation of subproofs and proofs, can improve the efficiency of determining and generating proofs, and can improve overall performance of the proof generation system. Such reuse of the subproofs 222 can be especially useful and efficient for recurring computations, which can be common in large-scale data analytics.

With further regard to the AI component 224, in accordance with various embodiments, the AI component 224 and/or the model 228 can perform an AI-based analysis on data, such as information relating to datasets (e.g., data analytics flows or other datasets), graphs, subgraphs, proofs, subproofs, computational tasks, computational results of sub-results, hashed values, applications, services, attributes, operations, functions, parameters, events, and/or other types of data, and/or feedback information (e.g., feedback information from a user, a device, or another data source). In some embodiments, with regard to a model 228, the AI component 224 can input such information into the (trained) model 228 for analysis (e.g., AI-based analysis) by the model 228 to update the model 228 or to generate output results (e.g., AI-related data relating to graphs, subgraphs, proofs, subproofs, computational tasks, computational results of sub-results, and/or other output results) based at least in part on the analysis of the input information.

In connection with or as part of such an AI-based analysis, the AI component 224 can employ, build (e.g., construct or create), and/or import, AI-based techniques and algorithms, AI-based models 228 (e.g., untrained or trained models), neural networks (e.g., untrained or trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about patterns relating to decomposing of graphs into subgraphs, determining or learning about patterns relating to determination and generation of subproofs relating to graphs that can be representative of datasets, determining or learning about patterns relating to computational tasks associated with subgraphs and subproofs, performing other desired functions or operations, and/or automating one or more functions or features of the disclosed subject matter, as more fully described herein.

The AI component 224 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 224 can examine the entirety or a subset of the data (e.g., the training data; operational data relating to operation of the proof manager component 102 and/or one or more servers or other devices; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In some embodiments, with regard to probabilities, the AI component 224 and/or the trained model(s) 228 can employ one or more threshold probabilities (e.g., threshold probability values) to facilitate making a determination. For instance, in making a determination (e.g., a determination of whether a first subproof can be linked to a second subproof, a determination of whether a previously generated subproof can be reused with respect to a subgraph of a subsequent workflow, or other determination), as part of the AI-based analysis of information, the AI component 224 and/or the trained model(s) 228 can determine a probability (e.g., a probability that linking of the first subproof to the second subproof is desirable (e.g., suitable, acceptable, wanted, or optimal) to maintain integrity of the data flow between those subgraphs, a probability that computational tasks associated with the previously generated subproof are same or sufficiently similar to computational tasks associated with the subgraph of the subsequent workflow such that the previously generated subproof can be reused with respect to the subgraph, or other probability), and can determine whether the probability (e.g., probability value) satisfies (e.g., meets or exceeds; or is at or greater than) a defined and applicable threshold probability. The AI component 224 and/or the trained model(s) 228 can make a determination (or prediction or inference) (e.g., a determination (or prediction or inference) of whether the first subproof can be, or is to be, linked to the second subproof, a determination (or prediction or inference) of whether the previously generated subproof can be, or is to be, reused with respect to the subgraph of the subsequent workflow, or other determination (or prediction or inference)) based at least in part on the results of analyzing (e.g., comparing) the probability to the defined and applicable threshold probability (e.g., threshold minimum probability value). As a non-limiting example, the AI component 224 and/or the trained model(s) 228 can make a determination (or prediction or inference) that the previously generated subproof can be, or is to be, reused with respect to the subgraph of the subsequent workflow based at least in part on determining that a probability that the previously generated subproof can be, or is to be, reused with respect to the subgraph of the subsequent workflow (or a probability that the computational tasks associated with the previously generated subproof satisfy the defined similarity criterion with respect to the computational tasks associated with the subgraph) satisfies the defined and applicable threshold probability (e.g., the probability is the highest probability, relative to other probabilities relating to whether the previously generated subproof can be, or is to be, reused with respect to the subgraph of the subsequent workflow, and satisfies the defined and applicable threshold probability). In other embodiments, the AI component 224 and/or the trained model(s) 228 can make a determination (or prediction or inference) that the previously generated subproof can be, or is to be, reused with respect to the subgraph of the subsequent workflow (or a determination (or prediction or inference) that the computational tasks associated with the previously generated subproof satisfy the defined similarity criterion with respect to the computational tasks associated with the subgraph) based at least in part on determining that a probability that the previously generated subproof can be, or is to be, reused with respect to the subgraph of the subsequent workflow is a highest probability relative to the other probabilities, without use of and/or without regard to a threshold probability.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 224 can employ a classifier that can perform an AI-based analysis on data. A classifier can map an input attribute vector, z=(z1, z2, z3, z4, . . . , zn), to a confidence that the input belongs to a class, as by f (z)=confidence (class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, the AI component 224 (e.g., employing the trainer component 226) can comprise, generate, and/or train (e.g., iteratively train) AI-based models 228 that can be trained to learn, determine, predict, or infer data patterns in data; a correlation, relationship, or causation between an item(s) of data and another item(s) of data (e.g., occurrence of the other item(s) of data or an event relating thereto); a correlation, relationship, or causation between an event and another event (e.g., occurrence of another event); relationships between subgraphs of a graph representative of a dataset; relationships between respective (e.g., different) subgraphs of respective (e.g., different) graphs representative of respective (e.g., different) datasets; and/or to perform other desired functions or operations, and/or to automate one or more functions or features of the disclosed subject matter, as described herein.

With further regard to the processor component 216 and the data store 218 of or associated with the proof manager component 102, the processor component 216 can be associated with (e.g., communicatively connected to) and can work in conjunction with other components of the proof manager component 102 and/or the system 100, including the proof key component 202, the graph generator component 204, the decomposer component 206, the proof generator component 208, the hasher component 210, the linker and aggregator component 212, the subproof manager component 214, the data store 218, the AI component 224, and/or other components of the proof manager component 102 and/or the system 100, to facilitate performing the various functions and operations of the proof manager component 102 and/or the system 100. The processor component 216 can employ one or more processors (e.g., one or more central processing units (CPUs), accelerators, graphics processing units (GPUs), application-specific integrated circuits (ASICs), field-programmable gate arrays (FPGAs), microprocessors, controllers, and/or microcontrollers that can process information relating to data, instructions, files, datasets (e.g., data analytics flows or other datasets), graphs (e.g., DAGs or other graphs), subgraphs, computational tasks, cryptographic keys, proofs (e.g., 220), subproofs (e.g., 222), computational results, computational sub-results, services, applications, AI/ML-based models, AI-related data, training data, feedback information, updates, predictions, inferences, thresholds (e.g., maximum, minimum, or other threshold values), weight values, data processing operations, messages, notifications, alarms, alerts, preferences (e.g., user or client preferences), hash values, metadata, hyperparameters, parameters, tables, mappings, policies, the defined proof management criteria, algorithms (e.g., enhanced proof generation management algorithms, enhanced subproof reuse algorithms, AI algorithms, hash algorithms, data compression algorithms, data decompression algorithms, and/or other algorithm), interfaces, protocols, tools, and/or other information, to facilitate operation of the proof manager component 102 and/or the system 100, and control data flow between the proof manager component 102 and/or other components (e.g., the proof key component 202, graph generator component 204, decomposer component 206, proof generator component 208, hasher component 210, linker and aggregator component 212, subproof manager component 214, data store 218, AI component 224, network equipment or components, communication network, device 104 or other device, server, node, application, service, user, or other entity) associated with the proof manager component 102 and/or the system 100.

The data store 218 can store data structures (e.g., user data, metadata), code structure(s) (e.g., modules, objects, hashes, classes, procedures) or instructions, information relating to data, instructions, files, datasets (e.g., data analytics flows or other datasets), graphs (e.g., DAGs or other graphs), subgraphs, computational tasks, cryptographic keys, proofs (e.g., 220), subproofs (e.g., 222), computational results, computational sub-results, services, applications, AI/ML-based models, AI-related data, training data, feedback information, updates, predictions, inferences, thresholds (e.g., maximum, minimum, or other threshold values), weight values, data processing operations, messages, notifications, alarms, alerts, preferences (e.g., user or client preferences), hash values, metadata, hyperparameters, parameters, tables, mappings, policies, the defined proof management criteria, algorithms (e.g., enhanced proof generation management algorithms, enhanced subproof reuse algorithms, AI algorithms, hash algorithms, data compression algorithms, data decompression algorithms, and/or other algorithm), interfaces, protocols, tools, and/or other information, to facilitate controlling or performing operations associated with the proof manager component 102 and/or the system 100. The data store 218 can comprise volatile and/or non-volatile memory, such as described herein. In an aspect, the processor component 216 can be functionally coupled (e.g., through a memory bus) to the data store 218 in order to store and retrieve information desired to operate and/or confer functionality, at least in part, to the proof key component 202, graph generator component 204, decomposer component 206, proof generator component 208, hasher component 210, linker and aggregator component 212, subproof manager component 214, processor component 216, data store 218, AI component 224, and/or other component of the proof manager component 102 and/or the system 100, and/or substantially any other operational aspects of the proof manager component 102 and/or the system 100.

The data store 218 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

With further regard to the processor component 506 and the data store 508 of or associated with the verifier manager component 106, the processor component 506 can be associated with (e.g., communicatively connected to) and can work in conjunction with other components of the verifier manager component 106 and/or the system 100, including the verifier key component 502, the verifier component 504, the data store 508, and/or other components of the verifier manager component 106 and/or the system 100, to facilitate performing the various functions and operations of the verifier manager component 106 and/or the system 100. The processor component 506 can employ one or more processors (e.g., one or more CPUs, accelerators, GPUs, ASICs, FPGAs, microprocessors, controllers, and/or microcontrollers that can process information relating to data, instructions, files, services, applications, cryptographic keys, proofs, computational results, thresholds (e.g., maximum, minimum, or other threshold values), weight values, data processing operations, messages, notifications, alarms, alerts, preferences (e.g., user or client preferences), hash values, metadata, hyperparameters, parameters, tables, mappings, policies, the defined proof management criteria, algorithms (e.g., proof verification and management algorithms, hash algorithms, data compression algorithms, data decompression algorithms, and/or other algorithm), interfaces, protocols, tools, and/or other information, to facilitate operation of the verifier manager component 106 and/or the system 100, and control data flow between the verifier manager component 106 and/or other components (e.g., the proof manager component 102, network equipment or components, communication network, device, server, node, application, service, user, or other entity) associated with the verifier manager component 106 and/or the system 100.

The data store 508 can store data structures (e.g., user data, metadata), code structure(s) (e.g., modules, objects, hashes, classes, procedures) or instructions, information relating to data, instructions, files, services, applications, cryptographic keys, proofs, computational results, thresholds (e.g., maximum, minimum, or other threshold values), weight values, data processing operations, messages, notifications, alarms, alerts, preferences (e.g., user or client preferences), hash values, metadata, hyperparameters, parameters, tables, mappings, policies, the defined proof management criteria, algorithms (e.g., proof verification and management algorithms, hash algorithms, data compression algorithms, data decompression algorithms, and/or other algorithm), interfaces, protocols, tools, and/or other information, to facilitate controlling or performing operations associated with the verifier manager component 106 and/or the system 100. The data store 508 can comprise volatile and/or non-volatile memory, such as described herein. In an aspect, the processor component 506 can be functionally coupled (e.g., through a memory bus) to the data store 508 in order to store and retrieve information desired to operate and/or confer functionality, at least in part, to the verifier key component 502, the verifier component 504, the processor component 506, the data store 508, and/or other component of the verifier manager component 106 and/or the system 100, and/or substantially any other operational aspects of the verifier manager component 106 and/or the system 100.

It is to be appreciated and understood that one or more components (e.g., the proof manager component 102, the device 104, the verifier manager component 106, the server(s) (e.g., server 602, server 604, and/or server 606), or other component) of the systems (e.g., system 100, system 600, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

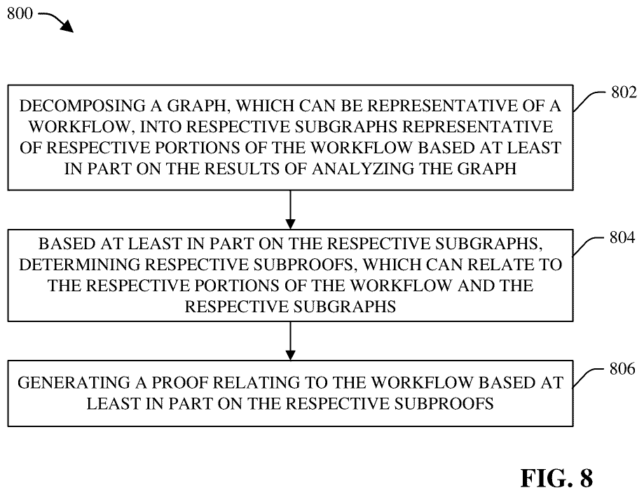

In view of the example systems and/or devices described herein, example methods that can be implemented in accordance with the disclosed subject matter can be further appreciated with reference to flowcharts in FIGS. 8-10. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 8 illustrates a flow chart of an example method 800 that can desirably (e.g., automatically, dynamically, suitably, efficiently, reliably, enhancedly, and/or optimally) perform and manage proof (e.g., ZKP) generation for a workflow (e.g., data analytics workflow or other type of workflow or dataset), in accordance with various aspects and embodiments of the disclosed subject matter. The method 800 can be employed by, for example, a system that can comprise the proof manager component that can comprise or be associated with the processor component, the data store, and/or other components.

At 802, a graph, which can be representative of a workflow, can be decomposed into respective subgraphs representative of respective portions of the workflow based at least in part on the results of analyzing the graph. For instance, the proof manager component can decompose (e.g., segment, divide, or separate) the graph (e.g., DAG) into the respective subgraphs (e.g., respective sub-DAGs), based at least in part on the results of analyzing the graph, wherein the graph can be representative of the workflow (e.g., data analytics workflow or other type of workflow or dataset), and wherein the respective subgraphs can be representative of respective portions of the workflow. The respective portions of the workflow can relate to respective computational tasks or operations that can be performed (e.g., by or using the proof manager component and one or more servers) on respective data items of the workflow.

At 804, based at least in part on the respective subgraphs, respective subproofs, which can relate to the respective portions of the workflow and the respective subgraphs, can be determined. For instance, based at least in part on the respective subgraphs, the proof manager component can determine and generate the respective subproofs that can relate to the respective portions of the workflow and the respective subgraphs, such as described herein.

At 806, a proof relating to the workflow can be generated based at least in part on the respective subproofs. For instance, the proof manager component can determine and generate the relating to the workflow based at least in part on the respective subproofs, such as described herein.

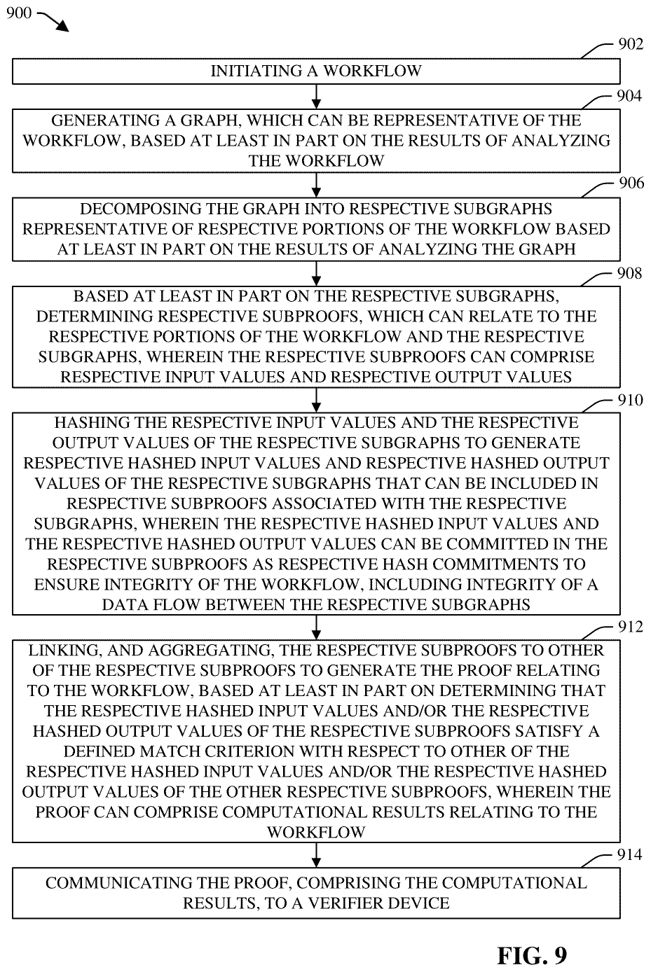

FIG. 9 depicts a flow chart of another example method 900 that can desirably (e.g., automatically, dynamically, suitably, efficiently, reliably, enhancedly, and/or optimally) perform and manage proof (e.g., ZKP) generation for a workflow (e.g., data analytics workflow or other type of workflow or dataset), in accordance with various aspects and embodiments of the disclosed subject matter. The method 900 can be employed by, for example, a system that can comprise the proof manager component that can comprise or be associated with the processor component, the data store, and/or other components.

At 902, a workflow can be initiated. At 904, a graph, which can be representative of the workflow, can be generated based at least in part on the results of analyzing the workflow. The proof manager component can receive and/or initiate the workflow (e.g., data analytics workflow or other type of workflow or dataset). In some embodiments, the proof manager component can generate the graph, which can be representative of the workflow, based at least in part on the results of analyzing the workflow.

At 906, the graph can be decomposed into respective subgraphs representative of respective portions of the workflow based at least in part on the results of analyzing the graph. For instance, the proof manager component can decompose the graph (e.g., DAG) into the respective subgraphs (e.g., respective sub-DAGs), based at least in part on the results of analyzing the graph, wherein the respective subgraphs can be representative of respective portions of the workflow. The respective portions of the workflow can relate to respective computational tasks or operations that can be performed (e.g., by or using the proof manager component and one or more servers) on respective data items of the workflow.

At 908, based at least in part on the respective subgraphs, respective subproofs, which can relate to the respective portions of the workflow and the respective subgraphs, can be determined, wherein the respective subproofs can comprise respective input values and respective output values. For instance, the proof manager component can determine and generate the respective subproofs, based at least in part on the respective subgraphs, wherein the respective subproofs can relate to the respective portions of the workflow and the respective subgraphs, such as described herein. As part of the determining and generating the respective subproofs, the proof manager component can perform or facilitate performance of the respective computational tasks and operations within the respective subgraphs to generate respective computational sub-results, wherein, based at least in part on the performance of the respective computational tasks and operations within the respective subgraphs, the respective input values and the respective output values can be determined, and can be included in the respective subproofs. In accordance with various embodiments, the proof manager component can utilize one server to determine and generate the respective subproofs based at least in part on the respective subgraphs, or can utilize two or more servers, in a distributed manner, to determine and generate the respective subproofs (e.g., in parallel) based at least in part on the respective subgraphs.

At 910, the respective input values and the respective output values of the respective subgraphs can be hashed to generate respective hashed input values and respective hashed output values of the respective subgraphs that can be included in respective subproofs associated with the respective subgraphs, wherein the respective hashed input values and the respective hashed output values can be committed in the respective subproofs as respective hash commitments to ensure integrity of the workflow, including integrity of a data flow between the respective subgraphs. For instance, respective edges between the respective subgraphs can be representative of respective data dependencies. Correspondingly, the respective subproofs (and the respective subgraphs) can comprise or can be associated with respective input values and the respective output values. The proof manager component can hash the respective input values and the respective output values of the respective subgraphs to generate the respective hashed input values and the respective hashed output values of the respective subgraphs, and those respective hashed input and output values can be included in the respective subproofs.

At 912, the respective subproofs can be linked to other of the respective subproofs and aggregated to generate the proof relating to the workflow, based at least in part on determining that the respective hashed input values and/or the respective hashed output values of the respective subproofs satisfy a defined match criterion with respect to other of the respective hashed input values and/or the respective hashed output values of the other respective subproofs, wherein the proof can comprise computational results relating to the workflow. For instance, the proof manager component can link the respective subproofs to other of the respective subproofs and aggregate the linked subproofs to generate the proof relating to the workflow, based at least in part on determining that the respective hashed input values and/or the respective hashed output values of the respective subproofs satisfy the defined match criterion with respect to other of the respective hashed input values and/or the respective hashed output values of the other respective subproofs, such as described herein. The proof manager component can determine the computational results relating to the workflow based at least in part on the respective computational sub-results of the respective subproofs.

At 914, the proof, comprising the computational results, can be communicated to a verifier device. The proof manager component can communicate the proof to the verifier device to facilitate presentation of the computational results to the verifier device and verification that the proof, including the computational results, is correct, without revealing, to the verifier device, underlying data of the workflow that was utilized to determine and generate the proof.

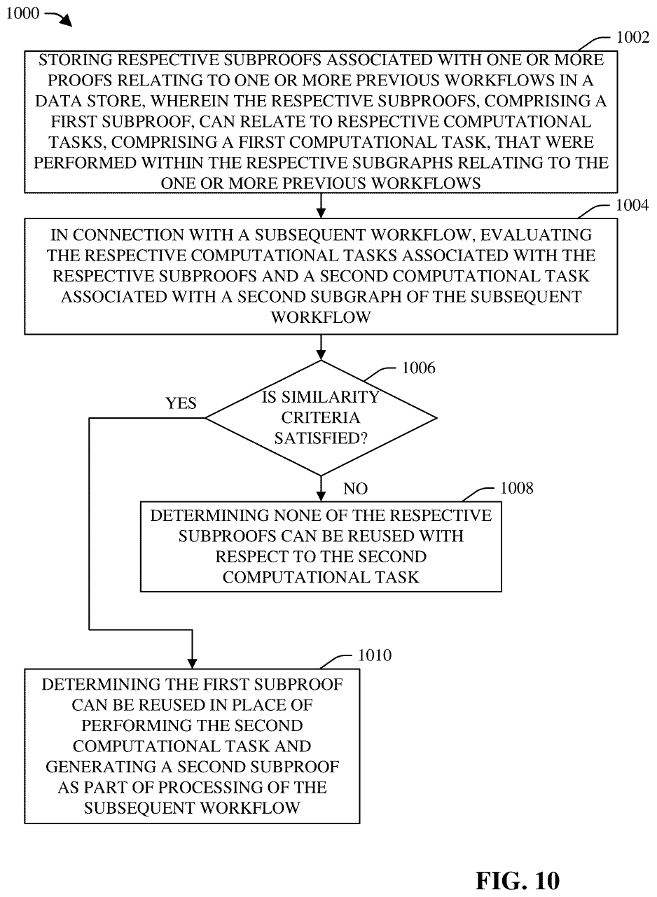

FIG. 10 illustrates a flow chart of an example method 1000 that can desirably (e.g., automatically, dynamically, suitably, reliably, efficiently, enhancedly, and/or optimally) reuse a previously generated subproof associated with a previously processed workflow for use in place of generating a new subproof in connection with processing a subsequent workflow, in accordance with various aspects and embodiments of the disclosed subject matter. The method 1000 can be employed by, for example, a system that can comprise the proof manager component that can comprise or be associated with the processor component, the data store, and/or other components.

At 1002, respective subproofs associated with one or more proofs relating to one or more previous workflows can be stored in a data store, wherein the respective subproofs, comprising a first subproof, can relate to respective computational tasks, comprising a first computational task, that were performed within the respective subgraphs relating to the one or more previous workflows. The proof manager component can store the respective subproofs associated with the one or more proofs in the data store to facilitate reuse of one or more of the respective subproofs with regard to subsequent workflows, such as described herein. The first subproof can relate to the first computational task which was performed within a first subgraph relating to a previous workflow, wherein the first subgraph can be representative of a portion of the previous workflow.

At 1004, in connection with a subsequent workflow, the respective computational tasks associated with the respective subproofs and a second computational task associated with a second subgraph of the subsequent workflow can be evaluated to facilitate determining whether any of the respective computational tasks satisfy the defined similarity criteria with respect to the second computational task. For instance, the proof manager component (e.g., employing the subproof manager component) can evaluate (e.g., analyze or check) the respective computational tasks and the second computational task to facilitate determining whether any of the respective computational tasks satisfy the defined similarity criteria with respect to the second computational task.

At 1006, based at least in part on the results of the evaluation, a determination can be made regarding whether any of the respective computational tasks associated with the respective subproofs satisfy the defined similarity criteria with respect to the second computational task associated with the second subgraph of the subsequent workflow. For instance, the proof manager component (e.g., employing the subproof manager component) can determine whether any of the respective computational tasks associated with the respective subproofs satisfy the defined similarity criteria with respect to the second computational task, based at least in part on the evaluation results.

If, based at least in part on the evaluation results, it is determined that none of the respective computational tasks associated with the respective subproofs satisfy the defined similarity criteria with respect to the second computational task associated with the second subgraph of the subsequent workflow, at 1008, a determination can be made that none of the respective subproofs can be reused with respect to the second computational task. For instance, if, based at least in part on the evaluation results, the proof manager component determines that none of the respective computational tasks associated with the respective subproofs satisfy the defined similarity criteria with respect to the second computational task, the proof manager component can determine that none of the respective subproofs can be reused with respect to the second computational task. Accordingly, the proof manager component can generate a second subproof based at least in part on the second subgraph, wherein, as part of generating the second subproof, the proof manager component can perform the second computational task within the second subgraph, such as described herein.

Referring again to reference numeral 1006, if, instead, at 1006, based at least in part on the evaluation results, it is determined that the first computational task associated with the first subproof satisfies the defined similarity criteria for reuse with respect to the second computational task, at 1010, a determination can be made that the first subproof can be reused in place of performing the second computational task and generating a second subproof as part of processing of the subsequent workflow. In some embodiments, if, based at least in part on the evaluation results, the proof manager component determines that the first computational task associated with the first subproof satisfies the defined similarity criteria for reuse with respect to the second computational task (e.g., the first computational task is same as or substantially same as the second computational task), a determination can be made that the first subproof can be reused in place of performing the second computational task and generating the second subproof as part of processing of the subsequent workflow. The proof manager component can reuse the first subproof, including the first computational sub-results from the performance of the first computational task, in place of generating the second subproof, instead of undesirably utilizing time and computational resources to perform the second computational task within the second subgraph relating to the subsequent workflow and generate the second subproof. The first computational sub-results can be the same or substantially same as the second computational sub-results that would have been obtained had the proof manager component performed the second computational task within the second subgraph and generated the second subproof. In some embodiments, the proof manager component can update and/or modify the first subproof, as desired (e.g., as wanted, suitable, appropriate, or needed) to account for any particular and/or minor differences between the first computational task and the second computational task.

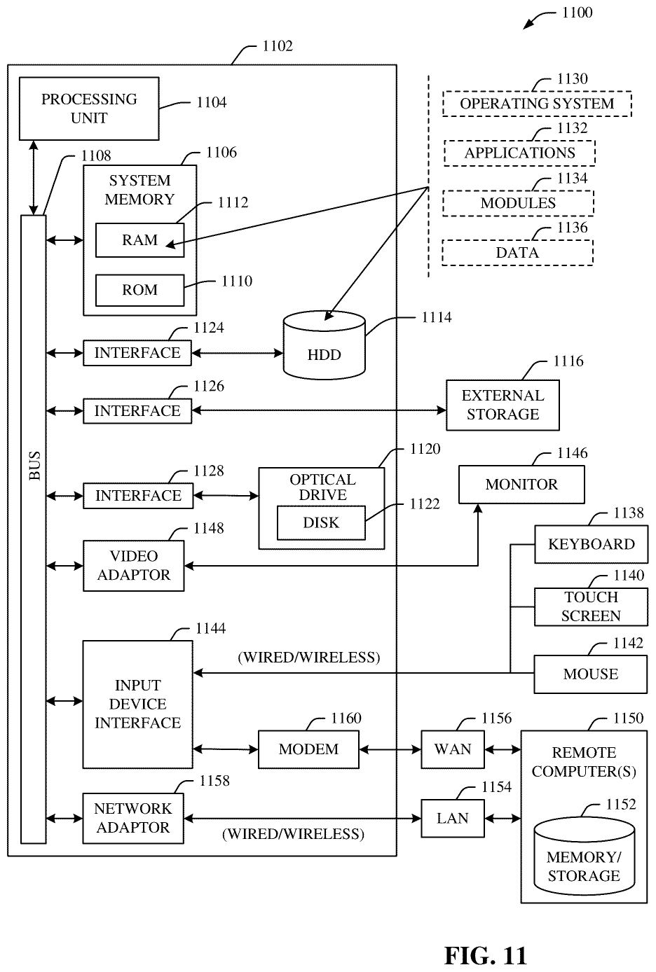

In order to provide additional context for various embodiments described herein, FIG. 11 and the following discussion are intended to provide a brief, general description of a suitable computing environment 1100 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 also can be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156, e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., proof manager component, verifier manager component, AI component, device, server, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
decomposing, by a system comprising at least one processor, a graph representative of a workflow into respective subgraphs representative of respective portions of the workflow;
based on the respective subgraphs, determining, by the system, respective subproofs relating to the respective portions of the workflow and the respective subgraphs; and
based on the respective subproofs, generating, by the system, a proof relating to the workflow.

2. The method of claim 1, wherein the proof is a zero-knowledge proof and the respective subproofs are respective zero-knowledge subproofs.

3. The method of claim 1, wherein the workflow is a data analytics workflow, wherein the graph is a directed acyclic graph, and wherein the respective subgraphs are respective directed acyclic subgraphs.

4. The method of claim 1, further comprising:
determining, by the system, respective sub-result data items relating to the workflow based on respective computational operations performed within the respective subgraphs, wherein the respective subproofs comprise the respective sub-result data items; and
determining, by the system, the proof, comprising result data, relating to the workflow based on the respective subproofs, wherein the result data is determined based on the respective sub-result data items.

5. The method of claim 4, further comprising:
communicating, by the system, the proof to a verifier device, wherein the proof facilitates verification that the proof, comprising the result data, is correct, without revealing, to the verifier device, underlying data of the workflow that was utilized to determine and generate the proof.

6. The method of claim 4, wherein respective edges between the respective subgraphs are representative of respective data dependencies, wherein the respective subgraphs comprise respective input values and respective output values, and wherein the method further comprises:
hashing, by the system, the respective input values and the respective output values of the respective subgraphs to generate respective hashed input values and respective hashed output values of the respective subgraphs that are included in the respective subproofs, wherein the respective hashed input values and the respective hashed output values are committed in the respective subproofs as respective hash commitments to ensure integrity of the workflow, including integrity of a data flow between the respective subgraphs; and
linking, by the system, the respective subproofs, based on the respective hashed input values and the respective hashed output values of the respective subproofs, to generate the proof.

7. The method of claim 6, wherein the respective subproofs comprise a first subproof and a second subproof, wherein the first subproof comprises a first hashed input value and a first hashed output value, wherein the second subproof comprises a second hashed input value and a second hashed output value, and wherein the method further comprises:
determining, by the system, that an output of the first subproof is to be linked to an input of the second subproof based on determining that the first hashed output value of the first subproof satisfies a defined match criterion with respect to the second hashed input value of the second subproof, wherein the linking comprises linking the output of the first subproof to the input of the second subproof based on determining that the output of the first subproof is to be linked to the input of the second subproof.

8. The method of claim 1, wherein the workflow is a first workflow, wherein the proof is a first proof, and wherein the method further comprises:
storing, by the system, the respective subproofs in a data store, wherein the respective subproofs are associated with respective computational tasks, comprising a first subproof associated with a first computational task that is performed within a first subgraph of the respective subgraphs;
in connection with a second workflow, determining, by the system, that a second computational task associated with the second workflow satisfies a defined similarity criterion with respect to the first computational task associated with the first subproof based on an analysis of the second computational task and the first computational task, wherein the second computational task is associated with a second subgraph representative of a portion of the second workflow;
based on the determining that the second computational task associated with the second workflow satisfies the defined similarity criterion with respect to the first computational task associated with the first subproof, retrieving, by the system, the first subproof from the data store; and
utilizing, by the system, the first subproof as a second subproof with respect to the second subgraph representative of the portion of the second workflow to facilitate generating a second proof relating to the second workflow.

9. The method of claim 1, wherein the respective subgraphs comprise a first subgraph representative of a first portion of the workflow and a second subgraph representative of a second portion of the workflow, wherein the respective subproofs comprise a first subproof relating to the first subgraph and a second subproof relating to the second subgraph, and wherein the determining of the respective subproofs comprises:
determining the first subproof based on the first subgraph; and
in parallel with the determining of the first subproof, determining the second subproof based on the second subgraph.

10. A system, comprising:
at least one memory that stores computer executable components; and
at least one processor that executes computer executable components stored in the at least one memory, wherein the computer executable components comprise:
a decomposer that decomposes a graph representative of a workflow into respective subgraphs relating to respective portions of the workflow; and
a proof generator that, based on the respective subgraphs, determines respective subproofs relating to the respective portions of the workflow and the respective subgraphs, to facilitate generation of a proof relating to the workflow.

11. The system of claim 10, wherein the workflow is a data analytics workflow, wherein the proof is a zero-knowledge proof and the respective subproofs comprise respective zero-knowledge subproofs, and wherein the graph is a directed acyclic graph and the respective subgraphs comprise respective directed acyclic subgraphs.

12. The system of claim 10, wherein the proof generator determines respective sub-result information items relating to the workflow based on respective computational tasks performed within the respective subgraphs, and determines and generates the proof, comprising result information, relating to the workflow based on the respective subproofs, and wherein the respective subproofs comprise the respective sub-result information data items.

13. The system of claim 12, wherein the proof generator transmits or facilitates transmission of the proof to a verifier device, and wherein the proof facilitates validation that the proof, comprising the result information, is accurate, without divulging, to the verifier device, underlying information of the workflow that was utilized to determine and generate the proof.

14. The system of claim 13, wherein respective edges between the respective subgraphs are representative of respective data dependencies, wherein the respective subgraphs comprise respective input values and respective output values, and wherein the computer executable components further comprise:
a hasher that hashes the respective input values and the respective output values of the respective subgraphs to generate respective hashed input values and respective hashed output values of the respective subgraphs that are part of the respective subproofs, wherein the respective hashed input values and the respective hashed output values are committed in the respective subproofs as respective hash commitments to ensure integrity of the workflow and integrity of a data flow between the respective subgraphs; and
a linker that links the respective subproofs, based on the respective hashed input values and the respective hashed output values of the respective subproofs, to facilitate generation of the proof.

15. The system of claim 14, wherein the respective subproofs comprise a first subproof and a second subproof, wherein the first subproof comprises a first hashed input value and a first hashed output value, wherein the second subproof comprises a second hashed input value and a second hashed output value, wherein the linker determines that an output of the first subproof is to be linked to an input of the second subproof based on a determination that the first hashed output value of the first subproof satisfies a defined match criterion with respect to the second hashed input value of the second subproof, and wherein, in response to determining that the output of the first subproof is to be linked to the input of the second subproof, the linker links the output of the first subproof to the input of the second subproof.

16. The system of claim 10, wherein the workflow is a first workflow, wherein the respective subproofs are associated with respective computational tasks, comprising a first subproof associated with a first computational task that is performed within a first subgraph of the respective subgraphs, wherein the proof is a first proof, wherein the proof generator stores or facilitates storage of the respective subproofs in a data store,
wherein, in connection with a second workflow, the proof generator determines that a second computational task associated with the second workflow satisfies a defined similarity criterion with respect to the first computational task associated with the first subproof based on a result of an analysis of the second computational task and the first computational task, wherein the second computational task is associated with a second subgraph representative of a portion of the second workflow,
wherein, based on determining that the second computational task satisfies the defined similarity criterion with respect to the first computational task, the proof generator obtains the first subproof from the data store, and
wherein the proof generator utilizes the first subproof as a second subproof with respect to the second subgraph representative of the portion of the second workflow to facilitate generating a second proof relating to the second workflow, or modifies the first subproof to generate a modified subproof and utilizes the modified subproof as the second subproof with respect to the second subgraph to facilitate generating the second proof.

17. The system of claim 10, wherein the respective subgraphs comprise a first subgraph representative of a first portion of the workflow and a second subgraph representative of a second portion of the workflow, wherein the respective subproofs comprise a first subproof relating to the first subgraph and a second subproof relating to the second subgraph, and wherein a first server is utilized to facilitate determination of the first subproof, based on the first subgraph, concurrently with a second server being utilized to facilitate determination of the second subproof, based on the second subgraph.

18. The system of claim 10, wherein the decomposer or the proof generator comprises or utilizes an accelerator unit, a graphics processing unit, a field-programmable gate array, or an application specific integrated circuit.

19. A non-transitory machine-readable medium, comprising executable instructions that, when executed by at least one processor, facilitate performance of operations, comprising:
segmenting a directed acyclic graph representative of a workflow into respective directed acyclic subgraphs relating to respective portions of the workflow;
based on the respective directed acyclic subgraphs, generating respective subproofs relating to the respective portions of the workflow and the respective directed acyclic subgraphs; and
based on the respective subproofs, generating a proof relating to the workflow.

20. The non-transitory machine-readable medium of claim 19, wherein the workflow is a data analytics workflow, wherein the proof is a zero-knowledge proof and the respective subproofs comprise respective zero-knowledge subproofs, and wherein the operations further comprise:
determining respective sub-result data items relating to the data analytics workflow based on respective computational tasks performed within the respective directed acyclic subgraphs, wherein the respective zero-knowledge subproofs comprise the respective sub-result data items;
determining the zero-knowledge proof, comprising result data, relating to the data analytics workflow based on the respective zero-knowledge subproofs, wherein the result data is determined based on the respective sub-result data items; and
transmitting the zero-knowledge proof to a verifier device, wherein the zero-knowledge proof facilitates verification that the zero-knowledge proof, comprising the result data, is accurate, without exposing, to the verifier device, underlying data of the data analytics workflow that was utilized to determine and generate the zero-knowledge proof.
